(19) United States
(12) Patent Application Publication
(10) Pub. No.: US 2014/0193052 A1
(43) Pub. Date: Jul. 10, 2014

(54) INFORMATION PROCESSING SYSTEM, INFORMATION PROCESSING METHOD, INFORMATION PROCESSING APPARATUS, CONTROL METHOD THEREOF AND CONTROL PROGRAM

(71) Applicants: Yoshiko Yoshihara, Tokyo (JP); Tomoharu Kiyuan, Tokyo (JP); Toru Sano, Tokyo (JP); Kenichi Kamijo, Tokyo (JP)

(72) Inventors: Yoshiko Yoshihara, Tokyo (JP); Tomoharu Kiyuan, Tokyo (JP); Toru Sano, Tokyo (JP); Kenichi Kamijo, Tokyo (JP)

(21) Appl. No.: 14/239,801

(22) PCT Filed: Aug. 22, 2012
(86) PCT No.: PCT/JP2012/005265

§ 371 Date: Feb. 20, 2014

(30) Foreign Application Priority Data
Aug. 23, 2011 (JP) 2011-182041

(51) Int. Cl. G06T 7/00

(52) U.S. Cl. CPC G06T 7/0012
USPC 382/128

(57) ABSTRACT

Disclosed is an information processing apparatus that supports diagnosis based on a tissue sample image obtained from imaging a biological tissue, including: a tissue sample image cutting unit that individually cuts out the tissue sample image from a plurality of slides that includes the plurality of tissue sample images; and a display position setting unit that sets a display position on a display screen where a reduced image of each tissue sample image is displayed, on the basis of a characteristic amount of each tissue sample image cut by the tissue sample image cutting unit.

### TECHNICAL FIELD

The present invention relates to an information processing technique that supports diagnosis based on a tissue sample image obtained from imaging a biological tissue.

### BACKGROUND ART

In the field of the above technology, Patent Document 1 discloses an apparatus that forms a tissue sample image on a slide as a thumbnail image in a slide unit and displays plural slides in a list.

### RELATED DOCUMENT

### Patent Document

[Patent Document 1] Japanese Unexamined Patent Publication No. 2011-117991

### DISCLOSURE OF THE INVENTION

However, the technique disclosed in Patent Document 1 provides the list display in the slide unit in all respects. Accordingly, when plural tissue sample images are present on a slide, even if there is an error with just one tissue sample on the slide, the entire process performs in the slide unit. Thus, a pathologist has to make diagnosis on the slide unit, which makes pathological diagnosis inefficient. Further, in the list display in the above-mentioned technique, a display position does not have a diagnostic meaning. Accordingly, the pathologist may not obtain diagnosis support information from the display position, and may not effectively use the list display as a diagnosis support.

The invention provides a technique that solves the above problems.

In order to achieve the object, according to the present invention, there is provided an information processing apparatus that supports diagnosis based on a tissue sample image obtained from imaging a biological tissue, including: a tissue sample image cutting unit that individually cuts out the tissue sample image from a plurality of slide images that includes the plurality of tissue sample images; and a display position setting unit that sets a display position on a display screen where a reduced image of each tissue sample image is displayed, on the basis of a characteristic amount of each tissue sample image cut by the tissue sample image cutting unit.

In order to achieve the object, according to the present invention, there is provided a control method of an information processing apparatus that supports diagnosis based on a tissue sample image obtained from imaging a biological tissue, including: individually cutting out the tissue sample image from a plurality of slide images that includes the plurality of tissue sample images; and setting a display position on a display screen where a reduced image of each tissue sample image is displayed, on the basis of a characteristic amount of each tissue sample image cut in the cutting of the tissue sample image.

In order to achieve the object, according to the present invention, there is provided a control program that causes a computer to execute a control method of an information processing apparatus that supports diagnosis based on a tissue sample image obtained from imaging a biological tissue, the control method including: individually cutting out the tissue sample image from a plurality of slide images that includes the plurality of tissue sample images; and setting a display position on a display screen where a reduced image of each tissue sample image is displayed, on the basis of a characteristic amount of each tissue sample image cut in the cutting of the tissue sample image.

In order to achieve the object, according to the present invention, there is provided an information processing system that supports diagnosis based on a tissue sample image obtained from imaging a biological tissue, including: an obtaining unit that obtains the captured tissue sample image; a tissue sample image cutting unit that individually cuts out the tissue sample image from a plurality of slide images that includes the plurality of tissue sample images; a display position setting unit that sets a display position on a display screen where a reduced image of each tissue sample image is displayed, on the basis of a characteristic amount of each tissue sample image cut by the tissue sample image cutting unit; and a display unit that displays the reduced image of each tissue sample image at the display position on the display screen set by the display position setting unit.

In order to achieve the object, according to the present invention, there is provided an information processing method that supports diagnosis based on a tissue sample image obtained from imaging a biological tissue, including: obtaining the captured tissue sample image; individually cutting out the tissue sample image from a plurality of slide images that includes the plurality of tissue sample images; setting a display position on a display screen where a reduced image of each tissue sample image is displayed, on the basis of a characteristic amount of each tissue sample image cut in the cutting of the tissue sample image; and displaying the reduced image of each tissue sample image at the display position on the display screen set in the setting of the display position.

According to the invention, by cutting a tissue sample image from a slide image and by reporting an evaluation result obtained in the unit of tissue sample images to a pathologist using a display position, it is possible to provide an effective diagnosis support.

### BRIEF DESCRIPTION OF THE DRAWINGS

Above described objects and other objects, features and advantages will become more apparent by preferred embodiments described below and the following accompanying drawings.

FIG. 1 is a diagram illustrating a configuration of an information processing apparatus according to a first embodiment of the invention.

FIG. 2 is a block diagram illustrating a configuration of an information processing system according to a second embodiment of the invention.

FIG. 3 is a block diagram illustrating configurations of a characteristic amount analysis unit and a characteristic amount DB according to the second embodiment of the invention.

FIG. 4 is a diagram illustrating a display screen of a communication terminal according to the second embodiment of the invention.

FIG. 5 is a diagram illustrating a configuration of a tissue sample image DB according to the second embodiment of the invention.

FIG. 6A is a diagram illustrating a configuration of a characteristic amount DB according to the second embodiment of the invention.

FIG. 6B is a diagram illustrating a configuration of a characteristic amount DB according to the second embodiment of the invention.

FIG. 6C is a diagram illustrating a configuration of a characteristic amount DB according to the second embodiment of the invention.

FIG. 6D is a diagram illustrating a configuration of a characteristic amount DB according to the second embodiment of the invention.

FIG. 6E is a diagram illustrating a configuration of a characteristic amount DB according to the second embodiment of the invention.

FIG. 7 is a diagram illustrating a configuration of a ranking table according to the second embodiment of the invention.

FIG. 8 is a diagram illustrating a configuration of a display screen format DB according to the second embodiment of the invention.

FIG. 9 is a diagram illustrating a configuration of a thumbnail list image according to the second embodiment of the invention.

FIG. 10 is a diagram illustrating a configuration of thumbnail list transmission data according to the second embodiment of the invention.

FIG. 11 is a diagram illustrating a hardware configuration of an information processing apparatus according to the second embodiment of the invention.

FIG. 12 is a flowchart illustrating a processing procedure of the information processing apparatus according to the second embodiment of the invention.

FIG. 13 is a block diagram illustrating a configuration of an information processing system according to a third embodiment of the invention.

FIG. 14 is a diagram illustrating a configuration of a ranking table according to the third embodiment of the invention.

FIG. 15 is a block diagram illustrating a configuration of an information processing system according to a fourth embodiment of the invention.

FIG. 16 is a diagram illustrating a display screen of a communication terminal according to the fourth embodiment of the invention.

FIG. 17A is a diagram illustrating a configuration of a multi-dimensional arrangement table according to the fourth embodiment of the invention.

FIG. 17B is a diagram illustrating a configuration of thumbnail arrangement data according to the fourth embodiment of the invention.

FIG. 18 is a flowchart illustrating a processing procedure of an information processing apparatus according to the fourth embodiment of the invention.

FIG. 19 is a block diagram illustrating a configuration of an information processing system according to a fifth embodiment of the invention.

FIG. 20 is a block diagram illustrating a configuration of an information processing system according to a sixth embodiment of the invention.

FIG. 21 is a diagram illustrating a configuration of a coloring DB according to the sixth embodiment of the invention.

FIG. 22 is a block diagram illustrating a configuration of an information processing system according to a seventh embodiment of the invention.

FIG. 23 is a diagram illustrating a display screen of a communication terminal according to an eighth embodiment of the invention.

### DESCRIPTION OF EMBODIMENTS

Hereinafter, exemplary embodiments of the present invention will be described in detail with reference to the accompanying drawings. However, constituent elements described in the following exemplary embodiments are merely illustrative, and the technical scope of the present invention is not intended to be limited only thereto.

### First Embodiment

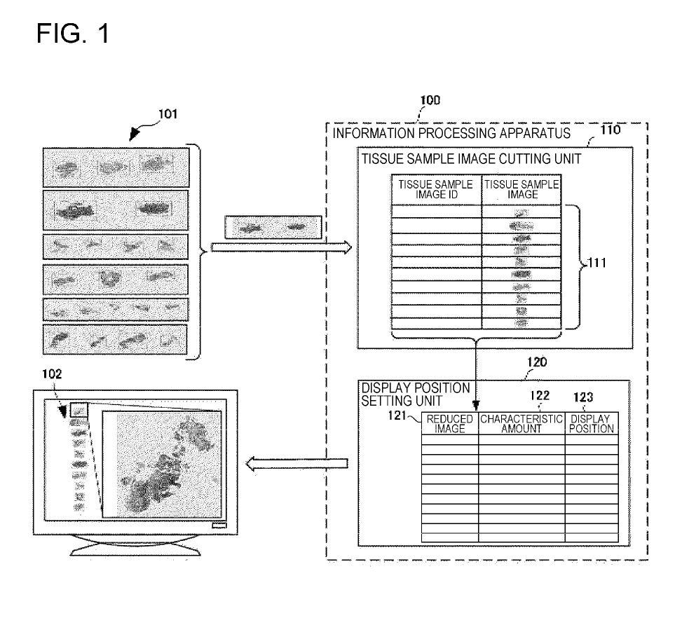

An information processing apparatus 100 according to a first embodiment of the invention will be described with reference to FIG. 1. The information processing apparatus 100 is an apparatus that supports diagnosis based on a tissue sample image obtained from imaging a biological tissue.

As shown in FIG. 1, the information processing apparatus 100 includes a tissue sample image cutting unit 110 and a display position setting unit 120. The tissue sample image cutting unit 110 individually cuts out a tissue sample image from plural slides 101 in which plural tissue sample images are included. The display position setting unit 120 sets a display position 123 on a display screen 102 that displays a reduced image 121 of each tissue sample image, on the basis of a characteristic amount 122 of each tissue sample image 111 cut by the tissue sample image cutting unit 110.

According to the present embodiment, it is possible to more effectively support diagnosis by notifying a pathologist, with reference to the display position, of an evaluation result obtained from cutting the tissue sample image from the slide images and performing evaluation in the unit of the tissue sample images.

### Second Embodiment

Next, an information processing system according to a second embodiment of the invention will be described. In the information processing system according to the second embodiment to the eighth embodiment, a case where slide images are received from plural communication terminals of pathologists through a network is shown, but processes of the present embodiment may also be realized by a single communication terminal or a stand-alone device.

In the present embodiment, ranking is performed for the tissue sample images cut from the slide images on the basis of the characteristic amount, and the display positions of the thumbnail images of the respective tissue sample images are set so that the ranking can be transmitted to the pathologists. In the present embodiment, the characteristic amount includes a degree of differentiation representing the degree of differentiation of cancer cells, a grade that is an evaluation of a histopathological grade of cancer cells, a nuclear grade which is an evaluation by the size or the shape of a cell nucleus, a structural grade representing a degree of gland tube formation, a number or a percentage of occurrences of nuclear fission of the cell nucleus, a degree of mucus secreted from the mucosa and the gland, and a possibility of a signet-ring cell cancer, and any combination thereof.

According to the present embodiment, the ranking information on the tissue sample images to be used as diagnostic targets by the pathologists is transmitted to the pathologists according to the display positions of the thumbnail images.

### <<Configuration of Information Processing System>>

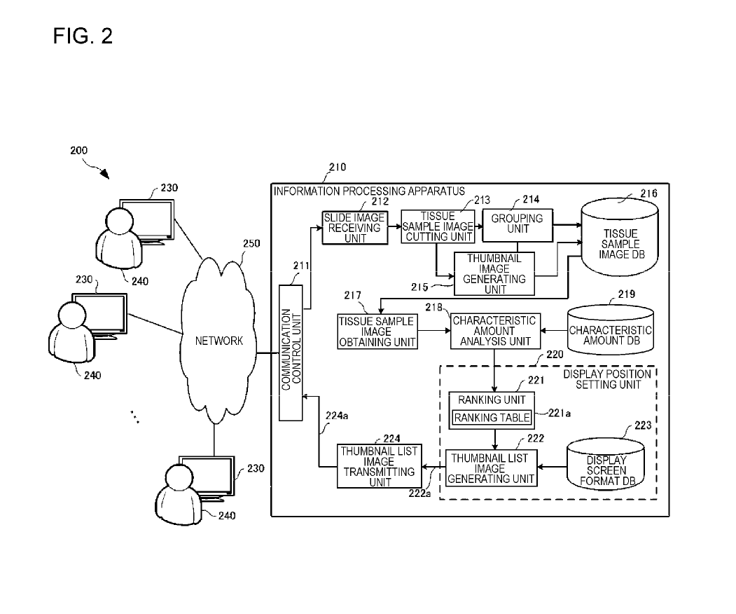

FIG. 2 is a block diagram illustrating a configuration of an information processing system 200 according to the present embodiment.

The information processing system 200 includes an information processing apparatus 210 that is a pathological diagnosis support apparatus connected through a network 250, and a communication terminal 230 that is operable by a pathologist 240 and receives a pathological diagnosis support. The network 250 may be a LAN in a hospital, or may be a public line or a wireless communication network connected with the outside of the hospital.

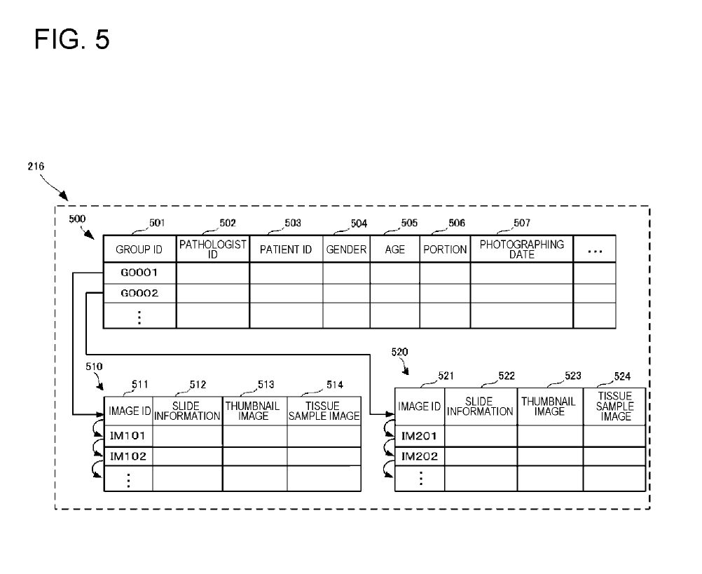

The information processing apparatus 210 includes a communication control unit 211 that controls communication with the communication terminal 230 through the network 250. The information processing apparatus 210 receives a slide image from the communication terminal 230 by a slide image receiving unit 212. Further, the information processing apparatus 210 cuts out an individual tissue sample image from the received slide image in a tissue sample image cutting unit 213. The information processing apparatus 210 may cut the individual tissue sample image in the tissue sample image cutting unit 213 by an image processing technique or the like that extracts an outline portion of the tissue sample image. Further, the tissue sample image cutting unit 213 associates slide information indicating the cut tissue sample image and the slide image including the tissue sample image with a tissue sample image ID that specifies the tissue sample image, and stores in a tissue sample image database (hereinafter, referred to as DB) 216 (see FIG. 5). Here, when slide images are received from plural communication terminals 230, or when slide images of different patients or portions are received from one communication terminal 230, the cut tissue sample images are divided into specific groups by a grouping unit 214. The grouping process will be described later.

When the slide images are received from the plural communication terminals 230, or when the slide images of the different patients or portions are received from one communication terminal 230, the grouping unit 214 divides the cut tissue sample images into tissue sample image groups in the unit of patients, portions of related tissues, or the like. Accordingly, when the slide images of the same portion of the same patient are received from one communication terminal 230, it is not necessary to perform the grouping, and thus, the grouping unit 214 may not execute the grouping process. Further, when the grouping process is executed, as shown in FIG. 5, for example, the grouping unit 214 associates group data in which information on patient IDs, portion IDs or the like used for the grouping is associated with group IDs that specify the groups, with the grouped tissue sample images, and stores the result in the tissue sample image DB 216. A thumbnail image generating unit 215 generates thumbnail image respectively corresponding to the cut tissue sample images. The generated thumbnail images are associated with the tissue sample image IDs of the tissue sample images based on the thumbnail images, and are stored in the tissue sample image DB 216.

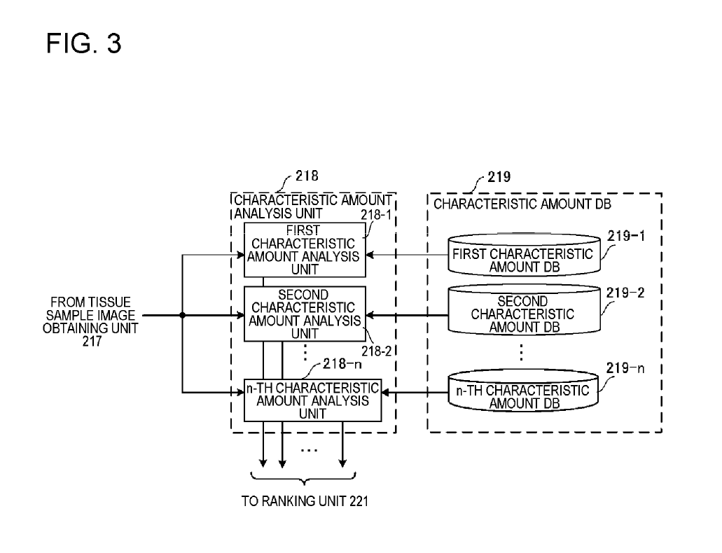

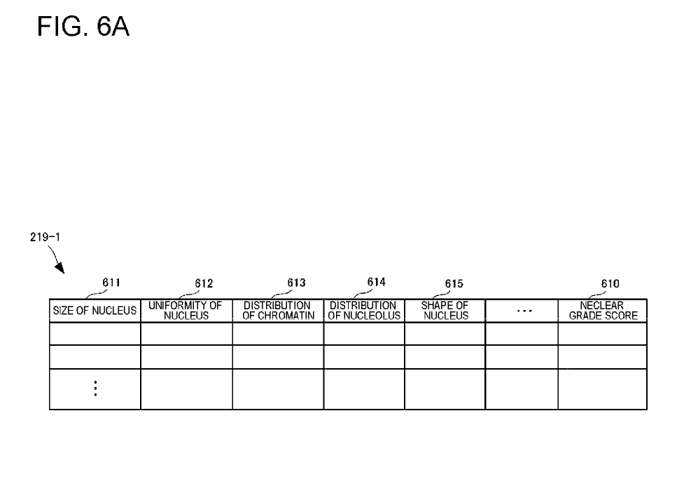

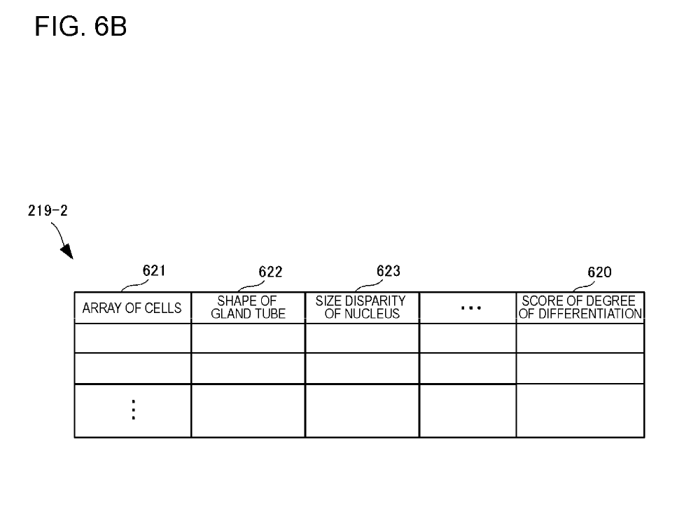

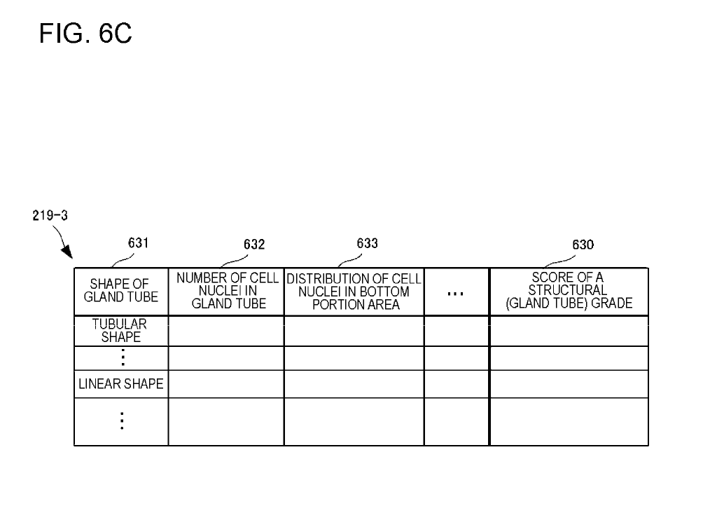

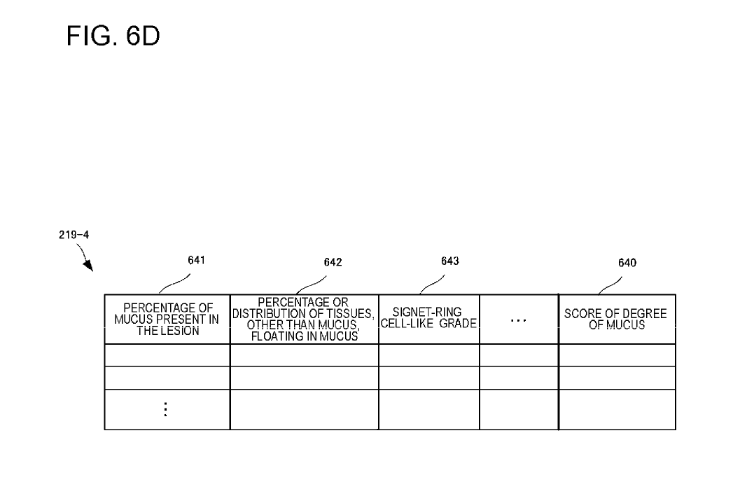

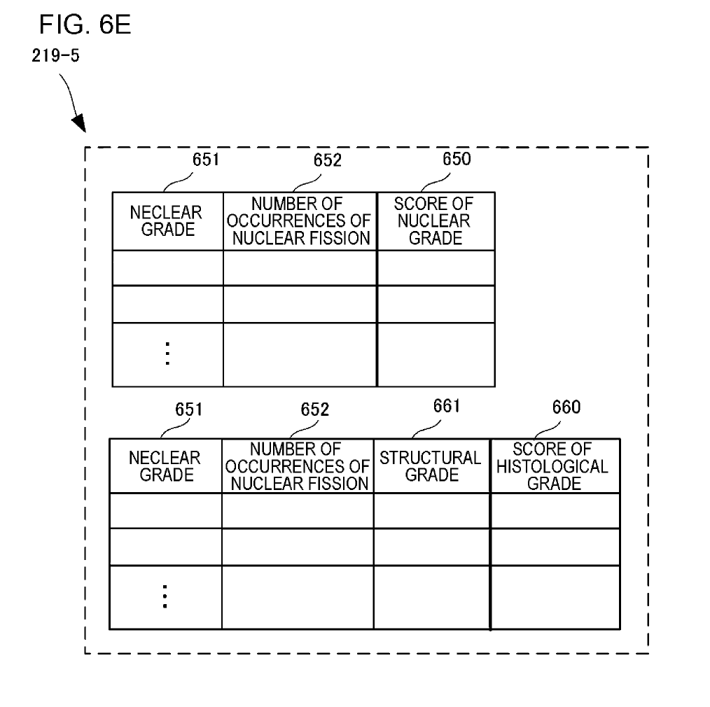

If reception completion of the slide image from a specific communication terminal 230 is notified, or if there is a display request for a thumbnail list from the communication terminal, a tissue sample image obtaining unit 217 reads each corresponding tissue sample image from the tissue sample image DB 216. Further, a characteristic amount of each tissue sample image is calculated using corresponding information in a characteristic amount database 219 (see FIGS. 6A to 6E) in a characteristic amount analysis unit 218. Here, the characteristic amount may be one, or may be plural as shown in FIG. 3.

### (Configurations of Characteristic Amount Analysis Unit and Characteristic Amount DB)

FIG. 3 is a block diagram illustrating configurations of the characteristic amount analysis unit 218 and the characteristic amount DB 219 according to the present embodiment when plural characteristic amounts are analyzed. The characteristic amount analysis unit 218 includes a first characteristic amount analysis unit 218-1, a second characteristic amount analysis unit 218-2, . . . , and an n-th characteristic amount analysis unit 218-n. Further, the characteristic amount DB 219 includes a first characteristic amount DB 219-1, a second characteristic amount DB 219-2, . . . , and an n-th characteristic amount DB 219-n. Each of the characteristic amount analysis units 218-1 to 218-n analyzes a characteristic amount of each tissue sample image from the tissue sample image obtaining unit 217 using information stored in each of the characteristic amount DBs 219-1 to 219-n, respectively.

The characteristic amount analyzed by the characteristic amount analysis unit 218 includes a degree of differentiation representing the degree of differentiation of cancer cells, a grade that is an evaluation of a histopathological grade of cancer cells, a nuclear grade which is an evaluation by the size or the shape of a cell nucleus, a structural grade representing a degree of gland tube formation, a number or a percentage of occurrences of nuclear fission of the cell nucleus, a degree of mucus secreted from the mucosa and the gland, and a possibility of a signet-ring cell cancer, for example. Further, the characteristic amount analyzed by the characteristic amount analysis unit 218 may include any combination of the characteristic amounts.

Returning to FIG. 2, a display position setting unit 220 performs ranking of the tissue sample images in an order to which the pathologist 240 has to pay attention, on the basis of the respective characteristic amounts or the combination characteristic amount from the characteristic amount analysis unit 218. Further, the display position setting unit 220 sets a display position on a display screen of the communication terminal 230 in which the ranking is transmittable to the pathologist 240. The display position setting unit 220 includes a ranking unit 221, a thumbnail list image generating unit 222, and a display screen format DB 223.

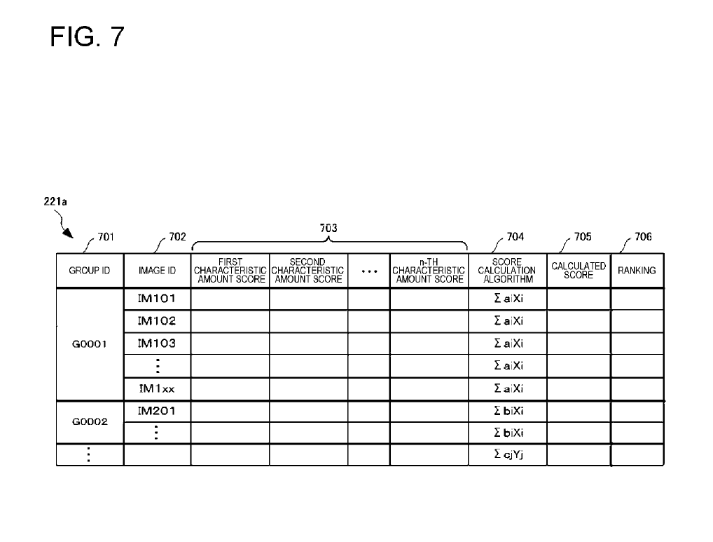

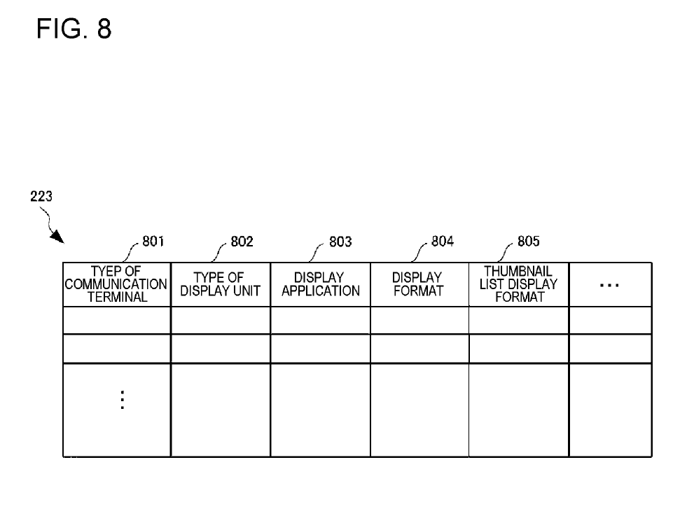

The ranking unit 221 performs the ranking of the tissue sample images in the order to which the pathologist 240 has to pay attention using a ranking table 221a (see FIG. 7). The display screen format DB 223 (see FIG. 8) stores display screen formats, correlating with the respective communication terminals 230, an application program, or requests of the pathologists 240. The thumbnail list image generating unit 222 arranges a thumbnail of each tissue sample image on a display screen format read from the display screen format DB 223, according to the ranking received from the ranking unit 221, to generate a thumbnail list image 222a.

A thumbnail image transmitting unit 224 generates thumbnail list transmission data 224a, to the communication terminal 230, in which the thumbnail list image 222a generated by the thumbnail list image generating unit 222 is assembled, and transmits the result to each communication terminal 230 through the communication control unit 211. The data to be transmitted may be only the thumbnail list image, or may be the entire display screen.

Synchronization of inquiry of the received slide images or thumbnail list and the thumbnail list image to be transmitted, using a communication terminal ID, a pathologist ID, a patient ID or the like, is a known technique, and thus, is not shown in FIG. 2 for simplicity of description. Further, processes of receiving selection information obtained by selecting one thumbnail image and enlarging and displaying the thumbnail image (actually, displaying a high-resolution tissue sample image corresponding to the thumbnail image) are not main characteristics of the present embodiment, and thus, are not shown in FIG. 2. In order to realize these processes, a selection information receiving unit that receives the selection information from the communication control unit 211 and an enlargement display instructing unit that instructs the communication terminal 230 to perform the enlargement display may be provided.

### (Display Screen of Communication Terminal)

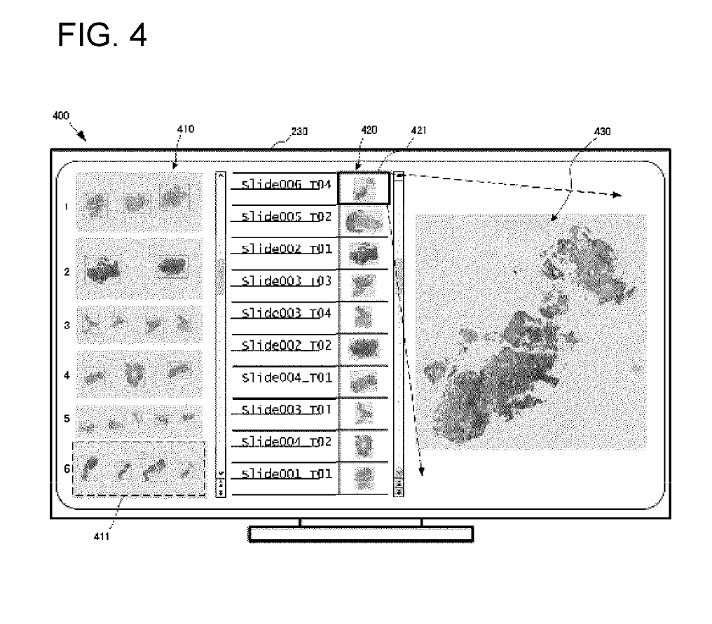

FIG. 4 is a diagram illustrating a display screen 400 of the communication terminal 230 according to the present embodiment. The format of the display screen in FIG. 4 is an example, and may be selected from a DB 223 of various display screen formats, according to the communication terminals 230, an application program or requests of the pathologists 240.

Three areas are shown in FIG. 4. The left area corresponds to a slide image area 410 where the slide images transmitted from the communication terminal 230 are displayed. The central area corresponds to a thumbnail list area 420 of the thumbnail list images where the thumbnails of the respective tissue sample images generated in the present embodiment are sequentially arranged to be viewed by the pathologists 240. In this example, the thumbnail images are arranged in the descending order from the top to the bottom to be viewed by the pathologists 240, but the thumbnail images may be arranged in the ascending order, may be arranged according to the size of the thumbnail images, or may be displayed in any manner as long as it can transmit an order to which the pathologist 240 has to pay attention. The right area corresponds to a tissue sample image area 430 where a tissue sample image corresponding to a thumbnail image 421 which has to be paid the most attention is displayed. In the example shown in FIG. 4, it is shown that the thumbnail image 421, which has to be paid the most attention, is included in a slide image 411.

The left slide image area 410 or the central thumbnail list area 420 may be scrollable. Other slide images or thumbnail images that cannot be displayed on one screen may be sequentially scrolled.

### (Tissue Sample Image DB)

FIG. 5 is a diagram illustrating a configuration of the tissue sample image DB 216 according to the present embodiment.

The tissue sample image DB 216 includes group data 500 for grouping the tissue sample images cut from the received slide images into groups to be used together in pathological diagnosis, and image data 510 or 520 that stores the tissue sample images that belong to each group and the generated thumbnail images. In the group data 500, a pathologist ID 502, a patient ID 503, a portion 506, a photographing date 507 and the like that characterize the group are stored in association with the group ID. Further, in the group data 500, gender 504, age 505 and the like of a patient which are information that characterizes the patient are also stored. The tissue sample image DB 216 stores the image data 510 or 520 associated with each group ID 501 (G0001/G0002). In the image data 510 or 520, slide information 512/522 in which the image is included, thumbnail image 513/523, and tissue sample image 514/524 are stored in association with the image ID 511/521 that identifies each tissue sample image.

### (Characteristic Amount DB)

Hereinafter, examples of the characteristic amount DB 219 that is prepared in advance for analysis of the characteristic amount will be described with reference to FIGS. 6A to 6E. The same characteristic amount DB is configured for other characteristic amounts.

FIG. 6A is a diagram illustrating a configuration example 219-1 of the characteristic amount DB 219 according to the present embodiment. FIG. 6A is the configuration example 219-1 of the characteristic amount DB when a nuclear grade that is an evaluation based on the size or shape of a cell nucleus is used as the characteristic amount.

The configuration example 219-1 of the characteristic amount DB stores conditions such as a size 611 of the nucleus, a uniformity 612 of the nucleus, a distribution 613 of a chromatin, a distribution 614 of a nucleolus, and a shape 615 of the nucleus, and a score 610 (the size of the characteristic amounts) of the nuclear grade corresponding to these conditions, in association with each portion of the body.

FIG. 6B is a diagram illustrating a configuration example 219-2 of the characteristic amount DB 219 according to the present embodiment. FIG. 6B is the configuration example 219-2 of the characteristic amount DB in the case where a degree of differentiation representing a degree of differentiation of a cancer area is used as the characteristic amount.

The configuration example 219-2 of the characteristic amount DB stores conditions such as an array 621 of cells, a shape 622 of a gland tube, and a size disparity 623 of the nucleus, and a score 620 (the size of the characteristic amounts) of a degree of differentiation corresponding to these conditions, in association with each portion of the body. Generally, the degree of differentiation is classified into a high differentiated state, a medium differentiated state, and a low differentiated state which are obtained by dividing the level. In this case, the configuration example 219-2 of the characteristic amount DB may allocate the degree of differentiation that is already level-divided, based on the scores 620 of the degree of differentiation of the image, for storage.

FIG. 6C is a diagram illustrating a configuration example 219-3 of the characteristic amount DB 219 according to the present embodiment. FIG. 6C is the configuration example 219-3 of the characteristic amount DB in the case where a gland tube grade, which is a structural grade, which is an evaluation of a gland tube or the like formed from a plurality of cells is used as the characteristic amount.

The configuration example 219-3 of the characteristic amount DB stores conditions such as a shape 631 of a gland tube including a tubular shape or linear shape, a number 632 of cell nuclei in the gland tube, a distribution 633 of cell nuclei in a bottom portion area, and a score 630 (the size of the characteristic amounts) of a structural (gland tube) grade corresponding to these conditions, in association with each portion of the body. The details of such the gland tube grade are described in Japanese Unexamined Patent Publication No. 2010-281636.

FIG. 6D is a diagram illustrating a configuration example 219-4 of the characteristic amount DB 219 according to the present embodiment. FIG. 6D is the configuration example 219-4 of the characteristic amount DB in the case where a degree of mucus which is an evaluation of the mucous area in lesion is used as the characteristic amount.

The configuration example 219-4 of the characteristic amount DB stores conditions such as a percentage 641 of mucus present in the lesion, a percentage or distribution 642 of tissues floating in the mucus other than the mucus, a signet ring cell-like grade 643, and a score 640 (the size of the characteristic amounts) of a degree of mucus corresponding to these conditions, in association with each portion of the body. In addition, see, for example, Patent Japanese Unexamined Patent Publication No. 2009-180539 for an extraction method of a mucus area.

FIG. 6E is a diagram illustrating a configuration example 219-5 of the characteristic amount DB 219 according to the present embodiment. FIG. 6E is the configuration example 219-5 of the characteristic amount DB in the case where a histological grade that is an evaluation of a histopathological grade of total cancer cells, including the nuclear grade in FIG. 6A or the like, is used as the characteristic amount.

The configuration example 219-5 of the characteristic amount DB stores conditions such as a nuclear grade 651 and the number of occurrence of nuclear fission 652, and a score 650 (the size of the characteristic amounts) of a nuclear grade corresponding to these conditions, in association with each portion of the body. Further, The configuration example 219-5 of the characteristic amount DB stores conditions of the nuclear grade 651, the number of occurrence of nuclear fission 652 and a structural grade 661, and a score 660 (the size of the characteristic amounts) of the histological grade corresponding to these conditions. As the structural grade 661, for example, a degree of gland tube formation may be included.

### (Ranking Table)

FIG. 7 is a diagram illustrating a configuration of the ranking table 221a according to the present embodiment.

The ranking table 221a stores each characteristic amount score 703 in association with an image ID 702 that identifies each tissue sample image, in each group ID 701. The ranking unit 221 calculates a calculated score 705 from all or some of the characteristic amount scores 703 (including only one characteristic amount) based on a score calculation algorithm 704. As the score calculation algorithm 704, in FIG. 7, a total weight that is the sum of weights (indicated by ai, bi or ci) given to the respective characteristic amount scores (indicated by Xi or Yi) is used, for example. However, this is an example, and the score calculation algorithm 704 is not limited thereto.

The ranking unit 221 sorts the calculated scores 705 calculated from all or some of the characteristic amount scores 703 based on the score calculation algorithm 704 to assign an (importance) ranking 706 to which the pathologist 240 has pay attention with respect to the respective tissue sample images in the group.

### (Display Screen Formation DB)

FIG. 8 is a diagram illustrating a configuration of the display screen format DB 223 according to the present embodiment.

As in the present embodiment, when the diagnosis support for the plural pathologists 240 is performed by the plural communication terminals 230 through the network 250, various communication terminals 230 may be connected, and various display format requests may be made by the pathologists 240. Accordingly, in the present embodiment, the display screen format DB 223 stores plural display application programs or plural thumbnail list display formats to cope with such a case. However, in the case of a diagnosis support program of a stand-alone device or a system in the same hospital, the display screen format DB 223 may store a common display application program or a common thumbnail list display format.

The display screen format DB 223 stores an adaptable display application program 803, a display format 804 and a thumbnail list display format 805, and is associated with the type of the communication terminal 801 or the type of the display unit 802. The pathologist 240 may select the display format 804 or the thumbnail list display format 805 by a selection instruction from the communication terminal 230.

### (Thumbnail List)

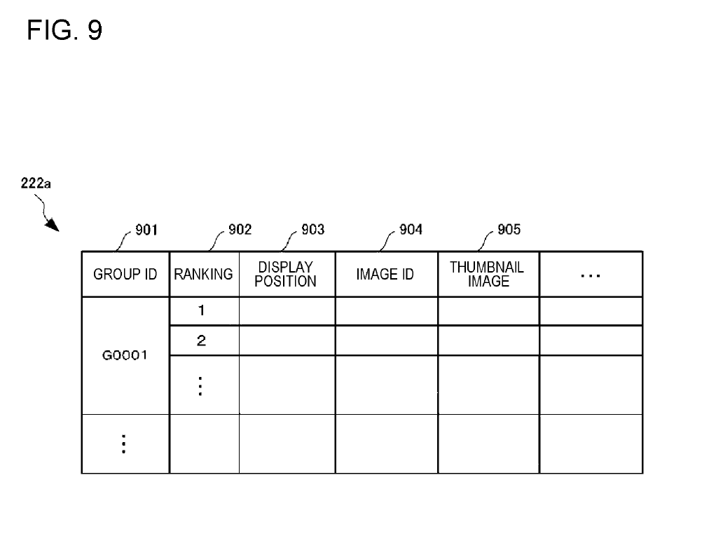

FIG. 9 is a diagram illustrating a configuration of the thumbnail list image 222a according to the present embodiment. The thumbnail list image 222a is generated in the thumbnail list image generating unit 222 and is transmitted to the thumbnail list image transmitting unit 224.

The thumbnail list image 222a stores a ranking 902 to be viewed by the pathologist 240, a display position 903, an image ID 904 of a tissue sample image to be displayed at the display position, and a thumbnail image 905, for each group ID 901. Here, the display position 903 may be on absolute coordinates on the display screen of the communication terminal 230, or may be on relative coordinates in the thumbnail list display format 805. However, it is preferable that the display position 903 be on the relative coordinates for realization of scroll of the thumbnail list as indicated on the display screen in FIG. 4.

### (Thumbnail List Transmission Data)

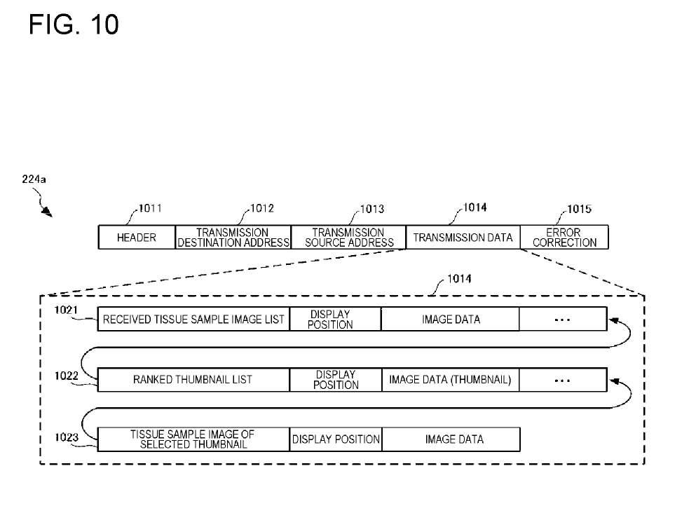

FIG. 10 is a diagram illustrating a configuration of the thumbnail list transmission data 224a according to the present embodiment. In FIG. 10, a case where the thumbnail list image transmitting unit 224 transmits one screen shown in FIG. 4 will be described. The thumbnail list image transmitting unit 224 transmits only the thumbnail list image displayed in the thumbnail list area 420, and the transmitted thumbnail list image may be synthesized with an image displayed in a different area in the communication terminal 230.

The thumbnail list transmission data 224a includes a header 1011, a transmission destination address 1012 of the communication terminal 230, a transmission source address 1013 of the information processing apparatus 210, transmission data 1014 that is display screen data, and an error correction 1015.

The transmission data 1014 that is the display screen data includes display data 1021 of the slide image area 410 displayed on the left side in FIG. 4, display data 1022 of the thumbnail list area 420 displayed at the center in FIG. 4, and display data 1023 of the tissue sample image area 430 displayed on the right side in FIG. 4.

<<Hardware configuration of information processing apparatus>>

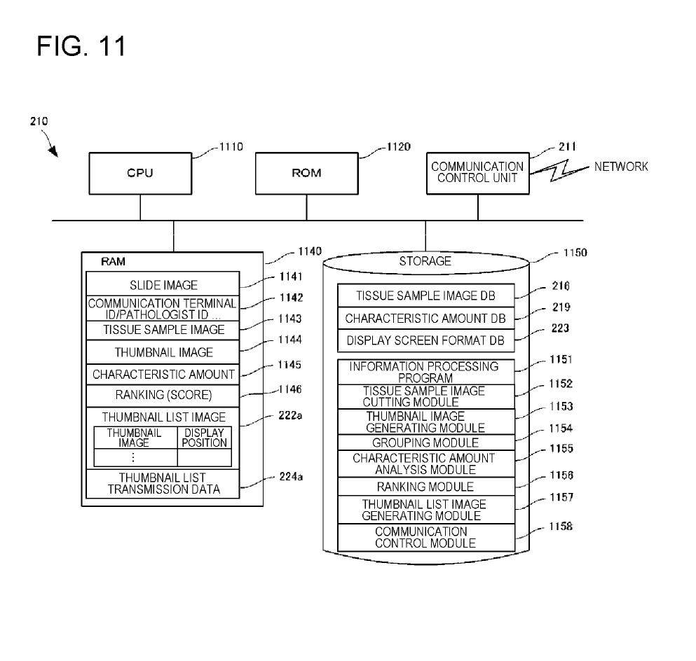

FIG. 11 is a diagram illustrating a hardware configuration of the information processing apparatus 210 according to the present embodiment.

In FIG. 11, a CPU 1110 is a calculation operation control processor, and realizes respective functional units of the information processing apparatus 210 in FIG. 2 by executing a program. A ROM 1120 stores fixing data and programs such as initial data and programs. A communication control unit 211 communicates with the communication terminals 230 of the pathologists. The communication may be performed in a wireless manner or in a wired manner.

A RAM 1140 is a random access memory used as a temporary storage work area by the CPU 1110. In the RAM 1140, a region where data necessary for realization of the present embodiment is stored is secured. A reference numeral 1141 represents a region where the slide image received from the communication terminal 230 of the pathologist through the network 250 is stored. A reference numeral 1142 represents a region where information for specifying the slide image 1141, such as a communication terminal ID, a pathologist ID and the like of the communication terminal 230 that transmits the slide image 1141 is stored. The information 1142 for specifying the slide image 1141 includes a patient ID, a portion where a tissue sample is taken, gender, age, a clinical history and the like, for example. A reference numeral 1143 represents a region where each tissue sample image cut from the slide image 1141 is stored. A reference numeral 1144 represents a region where the thumbnail image of each cut tissue sample image is stored. A reference numeral 1145 represents a region where one or plural characteristic amounts calculated by characteristic amount analysis are stored. A reference numeral 1146 represents a region where the ranking (scores) given to the tissue sample image 1143 (thumbnail image 1144) based on the calculated one or plural characteristic amounts 1145 is stored. A reference numeral 222a represents a region where the thumbnail list image generated by allocating a display position based on the ranking to each thumbnail image 1144 is stored (see FIG. 9). A reference numeral 224a represents a region where the thumbnail list transmission data to be transmitted to the communication terminal 230 is stored (see FIG. 10).

A storage 1150 stores a database, various parameters or the following data or programs necessary for realization of the present embodiment. A reference numeral 216 represents a tissue sample image DB in which the tissue sample image cut from the received slide image is stored in association with the thumbnail images (see FIG. 5). A reference numeral 219 represents a characteristic amount DB (see FIGS. 6A to 6E). A reference numeral 223 represents a display screen format DB (see FIG. 8). In the storage 1150, the following programs are stored. A reference numeral 1151 represents an information processing program that is a pathological diagnosis support program that executes the overall processes. A reference numeral 1152 represents a tissue sample image cutting module that cuts out the tissue sample image from the received slide image in the information processing program 1151. A reference numeral 1153 represents a thumbnail image generating module that generates the thumbnail image from each tissue sample image in the information processing program 1151. A reference numeral 1154 represents a grouping module that groups the cut tissue sample images in the information processing program 1151. A reference numeral 1155 represents a characteristic amount analysis module that analyzes the characteristic amount of the tissue sample images in the information processing program 1151. A reference numeral 1156 represents a ranking module that ranks the tissue sample images on the basis of one or plural characteristic amounts in the information processing program 1151. A reference numeral 1157 represents a thumbnail list image generating module that generates thumbnail list images in which the thumbnail images are arranged so that the ranking is transmittable to the pathologists, in the information processing program 1151. A reference numeral 1158 represents a communication control module that controls communication of the communication control unit 211 with the communication terminal 230 in the information processing program 1151.

In FIG. 11, only the data or program necessary for the present embodiment is shown, and general purpose data or program such as an OS is not shown.

<<Processing procedure of information processing apparatus>>

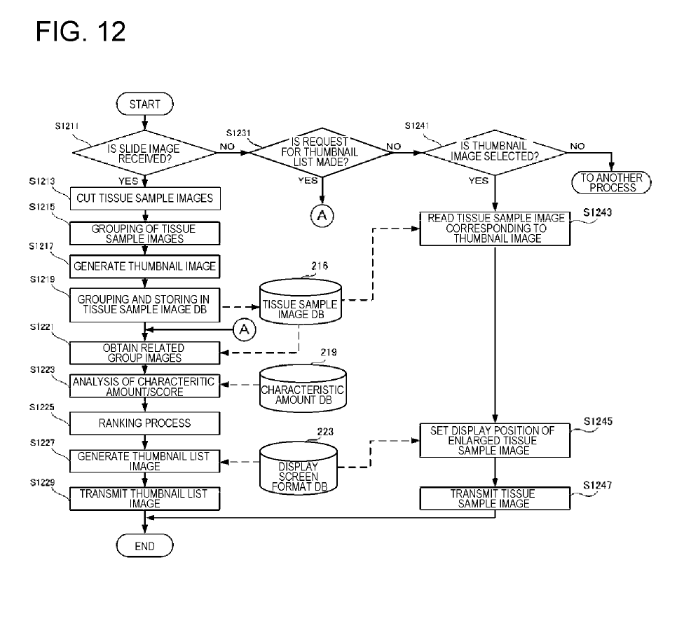

FIG. 12 is a flowchart illustrating a processing procedure of the information processing apparatus 210 according to the present embodiment. In the flowchart, the CPU 1110 in FIG. 11 executes the processing procedure using the RAM 1140 to realize the functional units of the information processing apparatus 210 in FIG. 2.

First, in step S1211, it is determined whether a slide image is received from the communication terminal 230. Further, in step S1231, it is determined whether a request for a thumbnail list is made from the communication terminal 230. Further, in step S1241, it is determined whether selection information indicating selection of one thumbnail image from the thumbnail list is received. If the determination result is No in all the steps, another process is performed. Here, the execution order of steps S1211, S1231 and S1241 is not limited to the disclosed order. In the present embodiment, the order of the shown processes may be modified within a range as long as they do not depart from the spirit of the invention.

If the slide image is received, the procedure goes to step S1213, and the information processing apparatus 210 cuts out tissue sample images from the slide image. The information processing apparatus 210 may cut the tissue sample image by an image processing technique or the like that extracts an outline portion of the tissue sample images. Then, in step S1215, the information processing apparatus 210 groups the respective cut tissue sample images. The information processing apparatus 210 groups the tissue sample images based on group data on pathologist IDs capable of specifying pathologists who transmit the tissue sample images, patient IDs indicating patients corresponding to the tissue sample images, portion IDs indicating portions included in the tissue sample images or the like, for example. Further, in step S1217, the information processing apparatus 210 generates a thumbnail image of each tissue sample image. Further, in step S1219, the information processing apparatus 210 associates the tissue sample images cut in step S1213 and slide information, the group data used for the grouping in step S1215 and the thumbnail images generated in step S1217 to be stored in the tissue sample image DB 216.

Then, in step S1221, the information processing apparatus 210 sequentially obtains the respective tissue sample images that belong to the same group from the tissue sample image DB 216. Further, instep S1223, the information processing apparatus 210 analyzes the characteristic amount of each obtained tissue sample image with reference to the characteristic amount DB 219, and calculates the score of the characteristic amount.

Further, in step S1225, the information processing apparatus 210 performs, for example, sorting on the basis of the calculated scores calculated from each characteristic amount of the tissue sample images based on a score calculation algorithm, to perform ranking of the tissue sample images in the same group. Further, in step S1227, the information processing apparatus 210 generates a thumbnail list image in which the thumbnail images are arranged based on the ranking in S1225 with reference to the display screen format DB 223 so that the ranking can be transmitted to the pathologist 240 by the display screen of the communication terminal 230. Further, in step S1229, the information processing apparatus 210 transmits the generated thumbnail list image to the communication terminal 230 that receives the slide image.

On the other hand, if there is a request for thumbnail list display from the communication terminal 230, the information processing apparatus 210 obtains information on the communication terminal ID, the pathologist ID, the patient ID, the portion and the like, and then, the procedure goes to step S1221. Further, the information processing apparatus 210 executes steps S1221 to S1229 for the group corresponding to the obtained information, and displays the thumbnail list to the communication terminal 230 related to the request.

If one thumbnail image is selected during the display of the thumbnail list, the procedure goes to step S1243, and the information processing apparatus 210 reads a tissue sample image corresponding to the selected thumbnail image from the tissue sample image DB 216. Further, in step S1245, the information processing apparatus 210 sets a display position of an enlarged tissue sample image. In this example, as shown in FIG. 4, the display position of the enlarged tissue sample image is set on the right half of the display screen. Further, in step S1247, the information processing apparatus 210 transmits the tissue sample image processed in step S1245 to the communication terminal 230. The communication terminal 230 displays the enlarged tissue sample image at the set display position. Here, for example, if image data having the maximum resolution is obtained in slide photographing for the tissue sample image and the tissue sample image having the maximum resolution is stored in the tissue sample image DB 216, the information processing apparatus 210 transmits the tissue sample image having the maximum resolution. Further, if the tissue sample image having the maximum resolution is not stored in the tissue sample image SDB 216, the information processing apparatus 210 obtains the tissue sample image having the maximum resolution in the communication terminal 230, and displays the tissue sample image having the maximum resolution in the tissue sample image area 430.

### Third Embodiment

Next, an information processing system according to a third embodiment of the invention will be described. The information processing system according to the present embodiment is different from the second embodiment in that the pathologist can select or set data that is a ranking reference from the communication terminal. In the present embodiment, a configuration for selecting or setting the data that is the ranking reference will be described. Since other configurations and operations are the same as in the second embodiment, the detailed description thereof will not be repeated.

According to the present embodiment, since the pathologist can determine the ranking of the tissue sample images that are diagnosis targets based on his or her experience and ability, it is possible to achieve a quick diagnosis.

### <<Configuration of Information Processing System>>

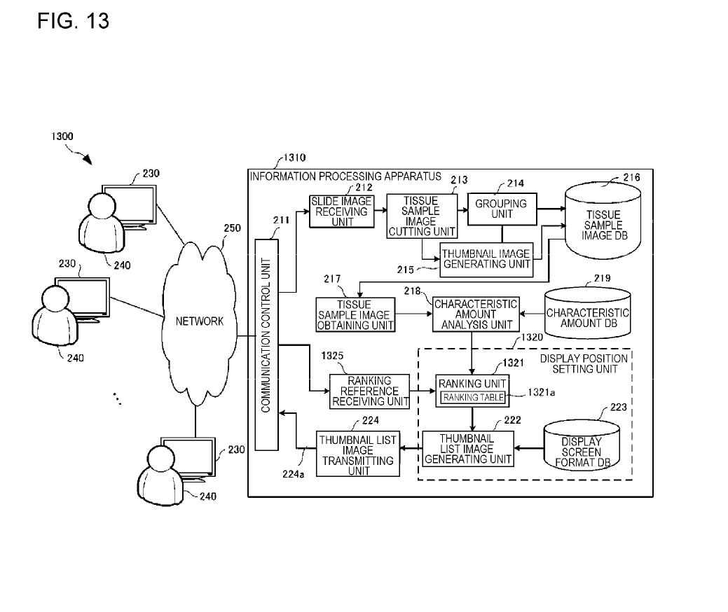

FIG. 13 is a block diagram illustrating a configuration of an information processing system 1300 according to the present embodiment. In FIG. 13, characteristic configurations different from the second embodiment in FIG. 2 are a ranking reference receiving unit 1325 and a display position setting unit 1320. In the display position setting unit 1320, a ranking unit 1321 is different from the second embodiment. Since other configurations and operations are the same as in the second embodiment, the detailed description thereof will not be repeated.

The ranking reference receiving unit 1325 receives the ranking reference set by the pathologist 240 from the communication terminal 230. The ranking unit 1321 creates a ranking table 1321a by the reference received by the ranking reference receiving unit 1325, and performs ranking of the tissue sample images in the order desired by the pathologist 240.

### (Ranking Table)

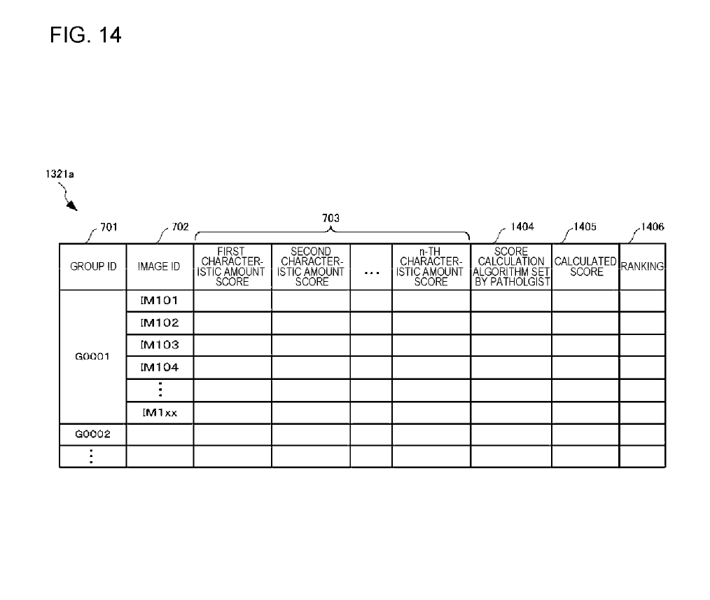

FIG. 14 is a diagram illustrating a configuration of the ranking table 1321a according to the present embodiment. The ranking table 1321a is basically the same as the ranking table 221a in FIG. 7, in which the same reference numerals are given to the same sections, and the description thereof will not be repeated.

In FIG. 14, the ranking reference received by the ranking reference receiving unit 1325 is stored to be rewritable as a score calculation algorithm 1404 set by the pathologist. Accordingly, calculated scores 1405 and a ranking 1406 indicating the sorting result thereof are changed by the setting of the pathologist 240. In the present embodiment, an example in which the score calculation algorithm 1404 is rewritten by the ranking reference transmitted from the communication terminal 230 has been described, but for example, the information processing apparatus 1310 may receive a setting instruction of the characteristic amount from the communication terminal 30, and may perform an operation such as addition of a new characteristic amount or deletion of an unused characteristic amount.

### Fourth Embodiment

Next, an information processing system according to a fourth embodiment of the invention will be described. The information processing system according to the present embodiment is different from the second embodiment in that thumbnail images of tissue sample images are arranged and displayed in a multi-dimensional space using characteristic amounts as axes. In the present embodiment, a configuration for multi-dimensionally arranging the thumbnail images of the tissue sample images using the characteristic amounts as the axes and an operation thereof will be described. Since other configurations and operations are the same as in the second embodiment, the detailed description thereof will not be repeated.

According to the present embodiment, since the pathologist can easily determine the tissue sample image that is a diagnosis target from the display position according to his or her experience and ability, it is possible to achieve a quick and correct diagnosis.

### <<Configuration of Information Processing System>>

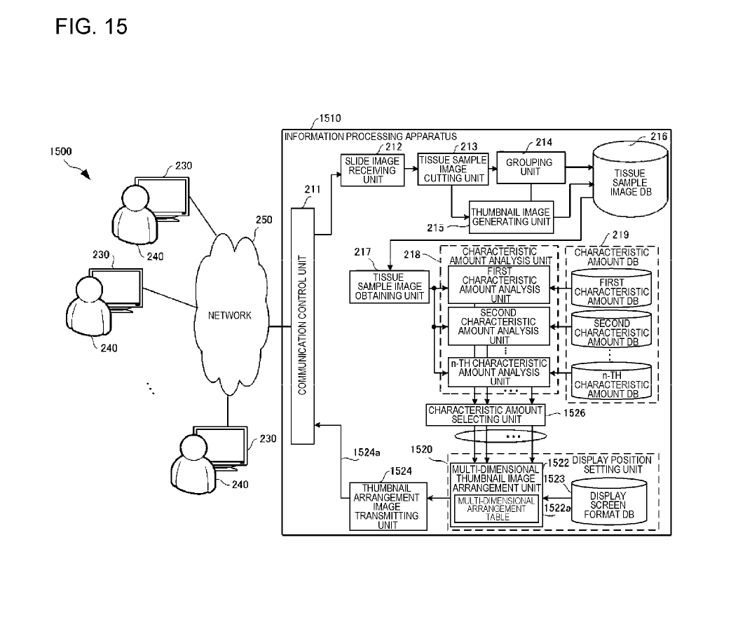

FIG. 15 is a block diagram illustrating a configuration of an information processing system 1500 according to the present embodiment. In FIG. 15, characteristic configurations different from in FIGS. 2 and 3 are a display position setting unit 1520 and a thumbnail arrangement image transmitting unit 1524. Since other configurations and operations are the same as in the second embodiment, the detailed description thereof will not be repeated.

The display position setting unit 1520 of the present embodiment includes a multi-dimensional thumbnail image arrangement unit 1522 and a display screen format DB 1523. The display screen format DB 1523 retains a format that determines a position on the display screen at which the thumbnail image is arranged and a direction to be used as the axis of the characteristic amount (not shown). The multi-dimensional thumbnail image arrangement unit 1522 multi-dimensionally arranges the thumbnail images based on the size of the characteristic amount using each characteristic amount as the axis, using the format read from the display screen format DB 1523 and the multi-dimensional arrangement table 1522a. In a real display screen, there is a possibility that a multi-dimensional display exceeding three dimensions is not provided for diagnosis support of the pathologist 240, a two-dimensional or three-dimensional display is preferable.

The thumbnail arrangement image transmitting unit 1524 transmits thumbnail arrangement data 1524a to the corresponding communication terminal 230 on the basis of the thumbnail arrangement image generated by the multi-dimensional thumbnail image arrangement unit 1522.

### (Display Screen of Communication Terminal)

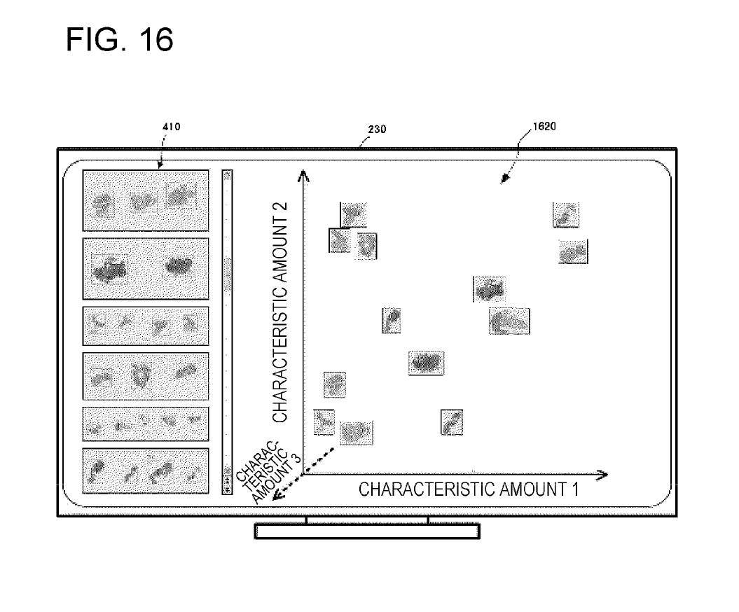

FIG. 16 is a diagram illustrating a display screen of the communication terminal 230 according to the present embodiment. The format of the display screen shown in FIG. 16 is an example, and may be selected from the display screen format DB 1523 based on the communication terminal 230, an application program or a request of the pathologist 240.

In FIG. 16, two areas are displayed. The left area corresponds to a slide image area 410 where the slide images transmitted from the communication terminal 230 are displayed, similar to FIG. 4. The right area corresponds to a thumbnail arrangement area 1620 where the thumbnail images are two-dimensionally (or three-dimensionally) arranged based on the size of the characteristic amount using a predetermined characteristic amount as an axis.

FIG. 16 shows the two-dimensional arrangement of the thumbnail images obtained by using a characteristic amount 1 as a transverse axis and using a characteristic amount 2 as a longitudinal axis. As the characteristic amounts that are used as the axes, for example, the characteristic amount 1 may employ the nuclear grade (see FIG. 6A), and the characteristic amount 2 may employ the structural (gland tube) grade (see FIG. 6C). Further, in the case of the three-dimensional arrangement, a characteristic amount 3 may be used as a perspective axis in a 3D display. In this case, as the characteristic amount 3, for example, the degree of mucus may be used (see FIG. 6D). The characteristic amounts that are used as the axes are not limited thereto.

### (Multi-Dimensional Arrangement Table)

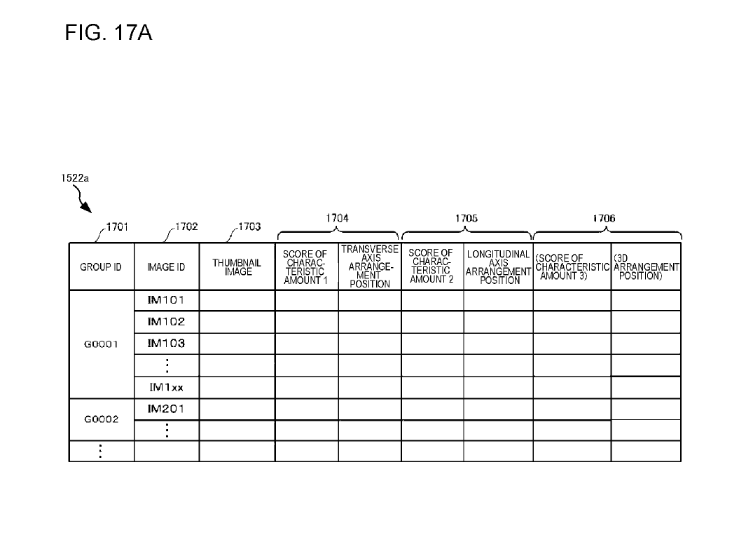

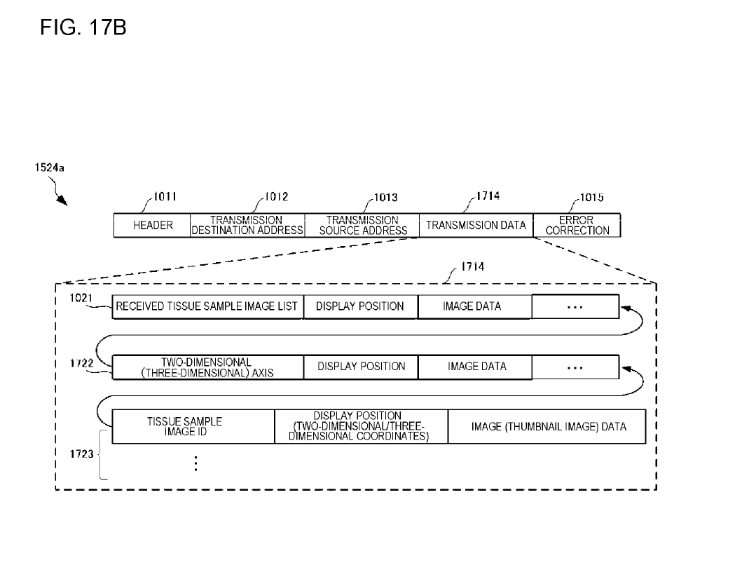

FIG. 17A is a block diagram illustrating a configuration of the multi-dimensional arrangement table 1522a according to the present embodiment.

The multi-dimensional arrangement table 1522a stores a thumbnail image 1703, a score of the characteristic amount 1 and a corresponding transverse axis arrangement position 1704, and a score of the characteristic amount 2 and a corresponding longitudinal axis arrangement position 1705, in association with an image ID 1702 that identifies each tissue sample image, in each group ID 1701. In the case of the three dimensions, the multi-dimensional arrangement table 1522a further stores a score of the characteristic amount 3 and a corresponding three-dimensional arrangement position 1706.

### (Thumbnail Arrangement Data)

FIG. 17B is a diagram illustrating a configuration of the thumbnail arrangement data 1524a according to the present embodiment. In FIG. 17B, a case where the thumbnail arrangement image transmitting unit 1524 transmits one screen shown in FIG. 16 will be described. The thumbnail arrangement image transmitting unit 1524 transmits only the thumbnail arrangement image displayed in the thumbnail arrangement area 1620, and the transmitted thumbnail arrangement image may be synthesized with an image displayed in a different area in the communication terminal 230. Further, in FIG. 17B, since only transmission data is different from FIG. 10, other configurations are given the same reference numerals as in FIG. 10, and the description thereof will not be repeated.

Transmission data 1714 that is display screen data includes display data 1021 on the slide image area 410 displayed in the left area in FIG. 16, display data 1722 indicating two-dimensional or three-dimensional axes displayed in the right area in FIG. 16, and display data 1723 on the thumbnail images arranged in the right area in FIG. 16.

### <<Processing Procedure of Information Processing Apparatus>>

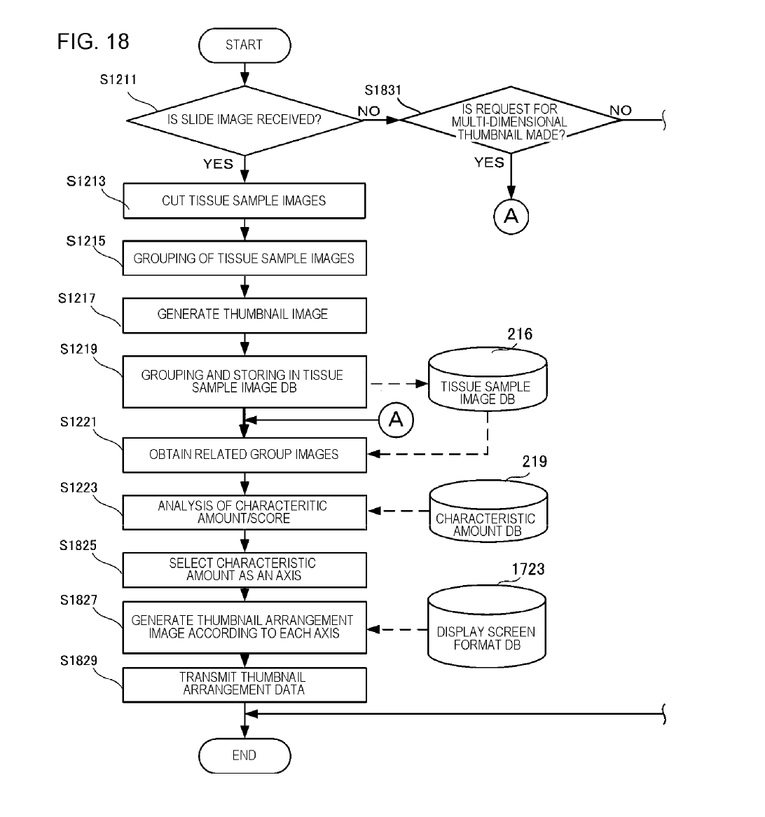

FIG. 18 is a flowchart illustrating a processing procedure of an information processing apparatus 1510 according to the present embodiment. In this flowchart, the CPU 1110 in FIG. 11 executes the processing procedure using the RAM 1140 to realize the functional units of the information processing apparatus 1510 in FIG. 15. The same processes as in FIG. 12 of the second embodiment are not shown, or are given the same reference numerals and the description thereof will not be repeated.

First, in step S1211, it is determined whether a slide image is received from the communication terminal 230. Further, in step S1831, it is determined whether a request for a multi-dimensional thumbnail display is made from the communication terminal 230. Here, the execution order of steps S1211 and S1831 is not limited to the disclosed order. In the present embodiment, the order of the shown processes may be modified in a range without departing from the spirit of the invention.

If the slide image is received, the procedure goes to step S1213, and the information processing apparatus 1510 executes the processes up to following step S1223. Then, in step S1825, the information processing apparatus 1510 selects a characteristic amount to be used as a display axis, from characteristic amounts that are given scores by analysis. Subsequently, in step S1827, the information processing apparatus 1510 generates a thumbnail arrangement image based on the score of the characteristic amount used as each axis with reference to a display screen format DB 1723. In step S1829, the information processing apparatus 1510 transmits thumbnail arrangement data 1524a corresponding to the generated thumbnail arrangement image to the communication terminal 230 that receives the slide image.

On the other hand, if there is the request for the multi-dimensional thumbnail display from the communication terminal 230, the procedure goes to step S1221, and the information processing apparatus 1510 executes steps S1221 to S1829 to generate the thumbnail arrangement image, and transmits the thumbnail arrangement data 1524a to the communication terminal 230 that makes the request for the multi-dimensional thumbnail display.

### Fifth Embodiment

Next, an information processing system according to a fifth embodiment of the invention will be described. The information processing system according to the present embodiment is different from the fourth embodiment in that the pathologist can select the axes of the characteristic amounts that are multi-dimensionally arranged through the communication terminal. In the present embodiment, a configuration for setting the characteristic amounts used as the axes will be described. Since other configurations and operations are the same as in the fourth embodiment, the detailed description thereof will not be repeated.

According to the present embodiment, since the pathologist can set the characteristic amounts used as the axes for selecting a tissue sample image that is a diagnosis target based on his or her experience and ability, it is possible to achieve a quick and correct diagnosis suitable for biological portions or symptoms.

### <<Configuration of Information Processing System>>

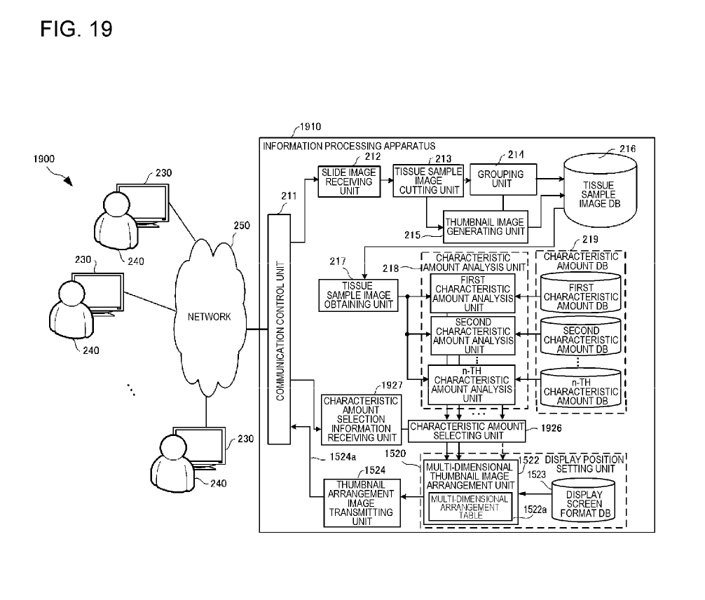

FIG. 19 is a block diagram illustrating a configuration of an information processing system 1900 according to the present embodiment. In FIG. 19, characteristic configurations different from the fourth embodiment in FIG. 15 are a characteristic amount selection information receiving unit 1927 and a characteristic amount selecting unit 1926. Since other configurations and operations are the same as in the second embodiment, the detailed description thereof will not be repeated.

The characteristic amount selection information receiving unit 1927 receives a selection instruction of the characteristic amounts used as the axes of the multi-dimensional display set by the pathologist 240, from the communication terminal 230. The characteristic amount selecting unit 1926 selects the characteristic amounts based on the selection instruction received by the characteristic amount selection information receiving unit 1927, to thereby perform the multi-dimensional display of the thumbnail image based on the axes of the characteristic amounts desired by the pathologist 240.

### Sixth Embodiment

Next, an information processing system according to a sixth embodiment of the invention will be described. The information processing system according to the present embodiment is different from the second embodiment in that an absolute evaluation of each tissue sample image is reported to the pathologist by color. In the present embodiment, a configuration for coloring will be described. Since other configurations and operations are the same as in the second embodiment, the detailed description thereof will not be repeated.

According to the present embodiment, since the order of the tissue sample images that are the diagnosis targets is reported to the pathologist and the degree of pathological urgency of the tissue sample images are reported using colors, it is possible to quickly and correctly make diagnosis based on the patient's state.

### <<Configuration of Information Processing System>>

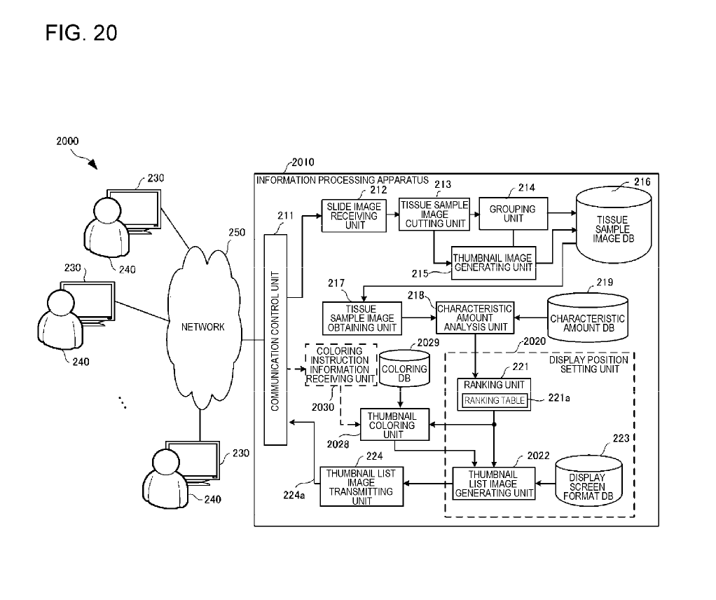

FIG. 20 is a block diagram illustrating a configuration of an information processing system 2000 according to the present embodiment. In FIG. 20, characteristic configurations different from the second embodiment in FIG. 2 are a thumbnail coloring unit 2028, a coloring DB 2029 and an option coloring instruction information receiving unit 2030. Further, in addition to these configurations, there is a change in a display position setting unit 2020. In the display position setting unit 2020, a thumbnail list image generating unit 2022 is different from the second embodiment. Since other configurations and operations are the same as in the second embodiment, the detailed description thereof will not be repeated.

The coloring DB 2029 stores a coloring group that colors each thumbnail image with hue or color brightness. The thumbnail coloring unit 2028 reads a coloring group corresponding to the score of the characteristic amount of the thumbnail image ranked in the ranking unit 221, with reference to the coloring DB 2029. Further, the thumbnail list image generating unit 2022 performs coloring of each thumbnail image based on the read coloring group. Thus, the pathologist 240 can recognize the absolute value of the score of the characteristic amount in addition to the relative ranking. Further, the option coloring instruction information receiving unit 2030 has a configuration in which the pathologist 240 can instruct, for example, a setting on whether each thumbnail is colored by hue or color brightness.

The thumbnail list image generating unit 2022 of the display position setting unit 2020 generates a thumbnail list image obtained by coloring each thumbnail image based on the coloring group read from the coloring DB 2029 by the thumbnail coloring unit 2028 based on the score of the characteristic amount, as described above. The color-coded thumbnail list image is obtained by adding color data to the data shown in FIG. 9 in the second embodiment, for example.

### (Coloring DB)

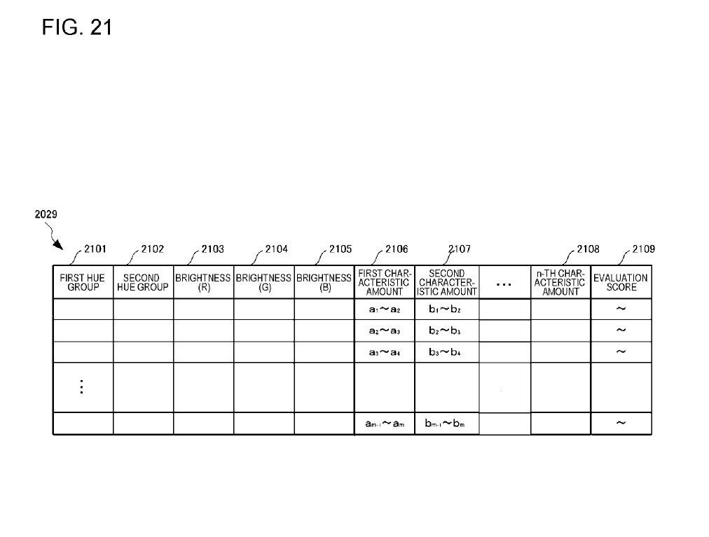

FIG. 21 is a diagram illustrating a configuration of the coloring DB 2029 according to the present embodiment.

The coloring DB 2029 stores a first hue group 2101 and a second hue group 2102 indicating hues corresponding to the ranges of the scores of the characteristic amounts, and the like. Further, the coloring DB 2029 stores a red (R) brightness value 2103, a green (G) brightness value 2104 and a blue (B) brightness value 2105, as brightness values of one color, for example. The information processing apparatus 2010 performs coloring using different hues or brightnesses based on the ranges of a first characteristic amount score 2106, a second characteristic amount score 2107 and an n-th characteristic amount score 2108 that are respective characteristic amount scores, for example. Further, the information processing apparatus 2010 may perform coloring using different hues or brightnesses based on the ranges of evaluation scores 2109 obtained on the basis of plural characteristic amounts.

If the red (R) brightness value 2103, the green (G) brightness value 2104 and the blue (B) brightness value 2105 are associated with three ranges of the characteristic amount scores, respectively, it is possible to recognize three characteristic amount scores from a color tint difference.

### Seventh Embodiment

Next, an information processing system according to a seventh embodiment of the invention will be described. The information processing system according to the present embodiment is different from the fourth embodiment in that an absolute evaluation of each tissue sample image is reported to the pathologist using colors in addition to the display at the multi-dimensional position using the characteristic amounts as the axes. In the present embodiment, a configuration for coloring will be described. Since other configurations and operations are the same as in the fourth embodiment, the detailed description thereof will not be repeated.

According to the present embodiment, since plural characteristic amounts of the tissue sample images that are the diagnosis targets are reported at display positions to the pathologist and the degree of pathological urgency of the tissue sample images are reported using colors, it is possible to quickly and correctly make diagnosis based on patient's state.

### <<Configuration of Information Processing System>>

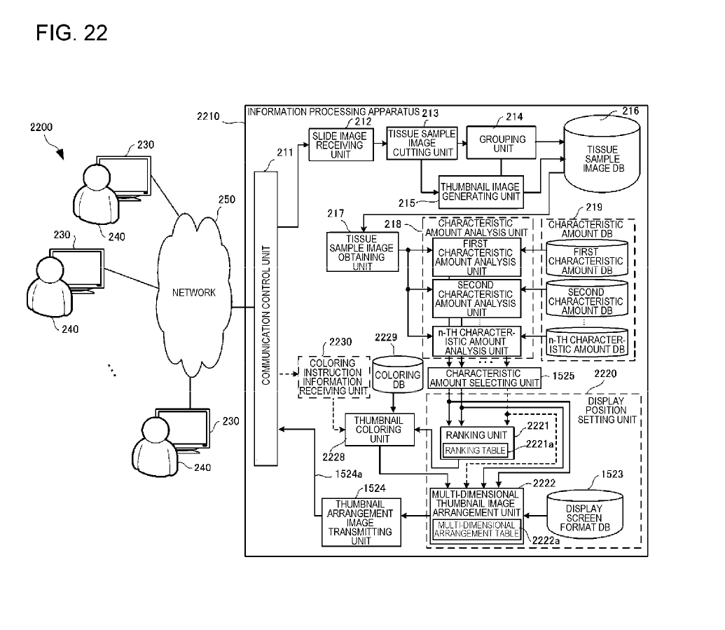

FIG. 22 is a block diagram illustrating a configuration of an information processing system 2200 according to the present embodiment. In FIG. 22, characteristic configurations different from the fourth embodiment in FIG. 15 are a thumbnail coloring unit 2228, a coloring DB 2229 and an option coloring instruction information receiving unit 2230. Further, in addition to these configurations, there is a change in a display position setting unit 2220. In the display position setting unit 2220, a ranking unit 2221 and a ranking table 2221a are added, and a multi-dimensional thumbnail image arrangement unit 2222 and a multi-dimensional arrangement table 2222a are different from the fourth embodiment. Since other configurations and operations are the same as in the second embodiment, the detailed description thereof will not be repeated.

Here, since the thumbnail coloring unit 2228, the coloring DB 2229 and the coloring instruction information receiving unit 2230 are the same as the thumbnail coloring unit 2028, the coloring DB 2029 and the coloring instruction information receiving unit 2030 in the sixth embodiment in their configurations, the description thereof will not be repeated. Further, since the ranking unit 2221 and the ranking table 2221a added to the display position setting unit 2220 are the same as in the second embodiment, description thereof will not be repeated. In the present embodiment, the ranking of the ranking unit 2221 is reported to the thumbnail coloring unit 2228, and thus, coloring to the thumbnail image is determined.

The multi-dimensional thumbnail image arrangement unit 2222 of the display position setting unit 2220 colors the thumbnail images, based on the coloring group read from the coloring DB 2029 by the thumbnail coloring unit 2228 based on the characteristic amount scores of the thumbnail images, and multi-dimensionally arranges the thumbnail images. The color-coded thumbnail arrangement images are obtained by adding color data to the data shown in FIG. 17 in the fourth embodiment, for example.

### Eighth Embodiment

Next, an information processing system according to an eighth embodiment of the invention will be described. The information processing system according to the present embodiment is different from the second and fourth embodiments in that the pathologist can select the position display based on the ranking and the display at the multi-dimensional position using the characteristic amounts as the axes. In the present embodiment, a configuration for selection of the pathologist will be described. Since other configurations and operations are the same as in the second or fourth embodiment, the detailed description thereof will not be repeated.

According to the present embodiment, since the pathologist can select the position display based on the ranking and the display at the multi-dimensional position using the characteristic amounts as the axes, it is possible to quickly and correctly make diagnosis based on patient's state and based on his or her experience and ability.

### (Display Screen of Communication Terminal)

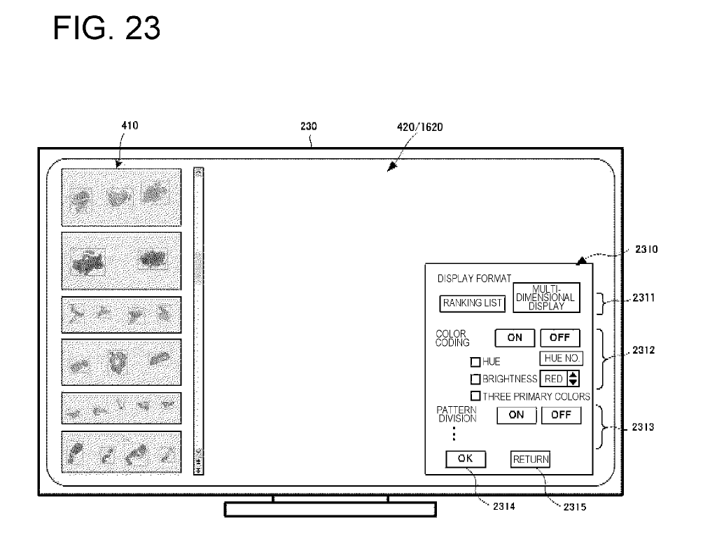

FIG. 23 is a diagram illustrating a display screen of the communication terminal 230 according to the present embodiment. The format of the display screen shown in FIG. 23 is an example, and may be optionally selected based on the communication terminal 230, an application program or a request of the pathologist 240.

FIG. 23 is a screen for selecting whether to perform the ranking list display in FIG. 4 or the multi-dimensional display in FIG. 16 before displaying the screen shown in FIG. 4 in the second embodiment or the screen shown in FIG. 16 in the fourth embodiment. The display screen in FIG. 23 includes the slide image area 410 where the received slide images are displayed and a display format area 2310 for selecting and instructing whether to perform the ranking list display or the multi-dimensional display. Further, at the display format area 2310, if the ranking list display is selected, the thumbnail list area 420 is displayed, and if the multi-dimensional display is selected, the thumbnail arrangement area 1620 is displayed.

The display format area 2310 includes an instruction button 2311 that selects and instructs whether to perform the ranking list display or the multi-dimensional display as described above, a setting button 2312 in color coding, and a setting button 2313 for pattern-division that is an option. Further, the display format area 2310 includes an OK button 2314 that validates the instruction and selection, and a return button 2315 for clearing the instruction and setting or for returning to the previous screen. The configuration of the display format area 2310 is not limited to the present example.

### Other Embodiments

Hereinbefore, the embodiments of the invention have been described, but any system or apparatus obtained by combining various characteristics included in the respective embodiments may be included in the scope of the invention.

Further, the invention may be applied to a system that includes plural devices, or may be applied to an apparatus that is a single body. Further, the invention may also be applied to a case where the control program that realizes the functions of the embodiment is directly or remotely supplied to the system or the apparatus. Accordingly, the control program installed in a computer to realize the functions of the invention in the computer, a medium that stores the control program, or World Wide Web (WWW) server from which the control program is downloaded are also included in the scope of the invention.

This application claims priority based on Japanese Patent Application No. 2011-182041 filed on Aug. 23, 2011, which is incorporated herein in its entirety by disclosure.

1. An information processing apparatus that supports diagnosis based on a tissue sample image obtained from imaging a biological tissue, comprising:
a tissue sample image cutting unit that individually cuts out the tissue sample image from a plurality of slide images that includes the plurality of tissue sample images; and
a display position setting unit that sets a display position on a display screen where a reduced image of each tissue sample image is displayed, on the basis of a characteristic amount of each tissue sample image cut by the tissue sample image cutting unit.

2. The image processing apparatus according to claim 1,
wherein the characteristic amount includes a degree of differentiation representing a degree of differentiation of cancer cells, a grade that is an evaluation of a histopathological grade of cancer cells, a nuclear grade which is an evaluation by a size or a shape of a cell nucleus, a structural grade representing a degree of gland tube formation, a number or percentage of occurrences of nuclear fission of the cell nucleus, a degree of mucus secreted from a mucosa and a gland, and a possibility of a signet-ring cell cancer, and any combination thereof.

3. The image processing apparatus according to claim 1,
wherein the reduced image is a thumbnail image.

4. The image processing apparatus according to claim 1,
wherein the display position setting unit includes a ranking unit that ranks the respective tissue sample images on the basis of the characteristic amount of each tissue sample image, and sets a display position where the reduced image of each tissue sample image is displayed based on the ranking given by the ranking unit.

5. The image processing apparatus according to claim 4,
wherein the ranking unit performs the ranking in the order of a total value of weights of the plurality of characteristic amounts of each tissue sample image.

6. The information processing apparatus according to claim 4, further comprising:
a ranking reference receiving unit that receives a setting of a ranking reference for the ranking of the respective tissue sample images,
wherein the ranking unit ranks the respective tissue sample images on the basis of the ranking reference received by the ranking reference receiving unit and the characteristic amounts of the respective tissue sample images.

7. The information processing apparatus according to claim 1,
wherein the display position setting unit sets the display position so that the display positions of the respective tissue sample images are multi-dimensionally arranged using the plurality of characteristic amounts of the respective tissue sample images as axes.

8. The information processing apparatus according to claim 7, further comprising:
a characteristic amount selecting unit that selects the plurality of characteristic amounts.

9. The information processing apparatus according to claim 1, further comprising:
a slide image receiving unit that receives the plurality of slide images that includes the plurality of tissue sample images through a network; and
a transmitting unit that transmits the reduced image of each tissue sample image in association with information indicating the display position through the network.

10. The information processing apparatus according to claim 9,
wherein the transmitting unit transmits the slide image from which the tissue sample image corresponding to the reduced image is read and information for identifying a position on the slide image in association with the reduced image.

11. The information processing apparatus according to claim 9, further comprising:
a selection information receiving unit that receives selection information to the reduced image transmitted by the transmitting unit; and
an enlargement display unit that makes an instruction for an enlargement display of the reduced image selected by the received selection information.

12. The information processing apparatus according to claim 1, further comprising:
a grouping unit that divides, when the plurality of slide images includes tissue sample images obtained from a plurality of patients or a plurality of tissues, the plurality of tissue sample images into tissue sample image groups obtained from related tissues of the same patient.

13. A control method of an information processing apparatus that supports diagnosis based on a tissue sample image obtained from imaging a biological tissue, comprising:
individually cutting out the tissue sample image from a plurality of slide images that includes the plurality of tissue sample images; and
setting a display position on a display screen where a reduced image of each tissue sample image is displayed, on the basis of a characteristic amount of each tissue sample image cut in the cutting of the tissue sample image.

14. A non-transitory computer readable medium that stores a control program that causes a computer to execute a control method of an information processing apparatus that supports diagnosis based on a tissue sample image obtained from imaging a biological tissue, the control method comprising:
individually cutting out the tissue sample image from a plurality of slide images that includes the plurality of tissue sample images; and
setting a display position on a display screen where a reduced image of each tissue sample image is displayed, on the basis of a characteristic amount of each tissue sample image cut in the cutting of the tissue sample image.

15. An information processing system that supports diagnosis based on a tissue sample image obtained from imaging a biological tissue, comprising:
an obtaining unit that obtains the captured tissue sample image;
a tissue sample image cutting unit that individually cuts out the tissue sample image from a plurality of slide images that includes the plurality of tissue sample images;
a display position setting unit that sets a display position on a display screen where a reduced image of each tissue sample image is displayed, on the basis of a characteristic amount of each tissue sample image cut by the tissue sample image cutting unit; and
a display unit that displays the reduced image of each tissue sample image at the display position on the display screen set by the display position setting unit.

16. An information processing method that supports diagnosis based on a tissue sample image obtained from imaging a biological tissue, comprising:
obtaining the captured tissue sample image;
individually cutting out the tissue sample image from a plurality of slide images that includes the plurality of tissue sample images;
setting a display position on a display screen where a reduced image of each tissue sample image is displayed, on the basis of a characteristic amount of each tissue sample image cut in the cutting of the tissue sample image; and
displaying the reduced image of each tissue sample image at the display position on the display screen set in the setting of the display position.
